(19) United States
(12) Patent Application Publication
(10) Pub. No.: US 2013/0120114 A1
(43) Pub. Date: May 16, 2013

(54) BIOFEEDBACK CONTROL SYSTEM AND METHOD FOR HUMAN-MACHINE INTERFACE

(71) Applicant: PIXART IMAGING INC., Hsin-Chu City (TW)

(72) Inventors: Ren-Hau GU, Hsin-Chu City (TW); Ming-Tsan KAO, Hsin-Chu City (TW); Sen-Huang HUANG, Hsin-Chu City (TW)

(73) Assignee: PIXART IMAGING INC., Hsin-Chu City (TW)

(21) Appl. No.: 13/671,258

(22) Filed: Nov. 7, 2012

(30) Foreign Application Priority Data
Nov. 16, 2011 (TW) 100141910

(51) Int. Cl. G06F 7/02

(52) U.S. Cl. CPC G06F 7/02
USPC 340/5.83; 340/5.82

(57) ABSTRACT

A biofeedback control system and method includes monitoring a physiological condition of a user to generate a sensing signal including a physiological information of the user, extracting a physiological variation information from the physiological information to generate a biofeedback signal, and generating a control signal based on the physiological variation information for controlling scenes, scenarios, background music or audio-visual effects of a program or a game. By this way, the biofeedback control system and method can trace a user's mood to automatically adjust a video output or an audio output of an electronic system where a program is playing or a game is running to enhance amusement.

### FIELD OF THE INVENTION

The present invention is related generally to a biofeedback control system and method and, more particularly, to a control system and method for automatically adjusting a video output or an audio output of an electronic system by tracing a user's moods.

### BACKGROUND OF THE INVENTION

Most entertainment programs, for example, movies and television drama, cartoons and performances, etc., are played with a single Scenario story and independent of the audience's feedback. Few types of live performances, for example, stage plays, magic shows and variety shows, etc., allow slight adjustment for answering to attending the audience's atmosphere to enhance amusement. Interaction between programs and audience is helpful to entertain the audience better. There has been, therefore, improvement made by preparing alternative scenario segments, so that the audience can make decisions according their preference along the development of the scenario and feel as if they are a part of the scenario. Such model is widely used by video game designers. For instance, a user of such video games may select between various scenes prepared in advance, and may choose different scenarios along the progress of the game. Multimedia further realizes the interactive operation. However, the existing interactive programs and games can only passively operate according to users' options and have no ability to automatically make adjustment by tracing a user's moods. For example, the existing video game devices may be able to recognize users' movements and force levels, but unable to identify users' moods, and thus, when a user playing a game feels nervous, excited or bored, the game will not automatically answer to such moods by changing scenes, scenarios, background music or audio-visual effects. On the other hand, users' initiative in choosing scenarios, in some respects, makes the development of the game or the program less anticipatable, and thereby, less exciting and less entertaining.

### SUMMARY OF THE INVENTION

An objective of the present invention is to provide a biofeedback control system and method for human-machine interface.

Another objective of the present invention is to provide a control system and method for automatically adjusting a video output or an audio output of an electronic system by tracing a user's moods.

According to the present invention, a biofeedback control system includes a physiological sensor configured to monitor a physiological condition of a user for generating a sensing signal including a physiological information of the user, a physiological condition analyzer operative to extract a physiological variation information from the physiological information for generating a biofeedback signal, and a control unit configured to generate a control signal based on the physiological variation information for controlling scenes, scenarios, background music or audio-visual effects of a program or a game.

According to the present invention, a biofeedback control method includes monitoring a physiological condition of a user for generating a sensing signal including a physiological information of the user, extracting a physiological variation information from the physiological information for generating a biofeedback signal, and generating a control signal based on the physiological variation information for controlling scenes, scenarios, background music or audio-visual effects of a program or a game.

### BRIEF DESCRIPTION OF THE DRAWINGS

These and other objectives, features and advantages of the present invention will become apparent to those skilled in the art upon consideration of the following description of the preferred embodiments according to the present invention taken in conjunction with the accompanying drawings, in which:

FIG. 1 is an embodiment of a biofeedback control system according to the present invention;

FIG. 2 is a first embodiment of the biofeedback control system shown in FIG. 1;

FIG. 3 is a second embodiment of the biofeedback control system shown in FIG. 1;

FIG. 4 is a diagram depicting the progress of a program having scenarios controlled by the biofeedback control system shown in FIG. 1 in an embodiment;

FIG. 5 is a diagram depicting the progress of a video game having scenarios controlled by the biofeedback control system shown in FIG. 1 in an embodiment;

FIG. 6 is a diagram depicting a video game having scenes controlled by the biofeedback control system shown in FIG. 1 in an embodiment; and

FIG. 7 is a diagram depicting a program or a game having an audio-visual effect controlled by the biofeedback control system shown in FIG. 1 in an embodiment.

### DETAILED DESCRIPTION OF THE INVENTION

The term “mood” refers to a psychological situation, usually accompanied by physical reaction such as heartbeat and behavioral reaction, for example, facial expressions and voices. When a mood is aroused, the accompanying behavioral reaction is more controllable as compared to the physical reaction that is involuntary. Therefore, it is the involuntariness of physical reaction that truly reflects the moods of a human being. The present invention thus provides a biofeedback control system and method for human-machine interface, which combines a physiological condition of a user of an electronic system into the control of the electronic system, such that the electronic system may adjust contents, such as scenes, scenarios, background music, audio-visual effects, etc., of a program or a game by tracing a mood of the user, to thereby enhance amusement. In the full text of this disclosure, a “program” refers to a file that is designed to be played or operated in an electronic system and may be a file exhibiting images, voices or any combination thereof.

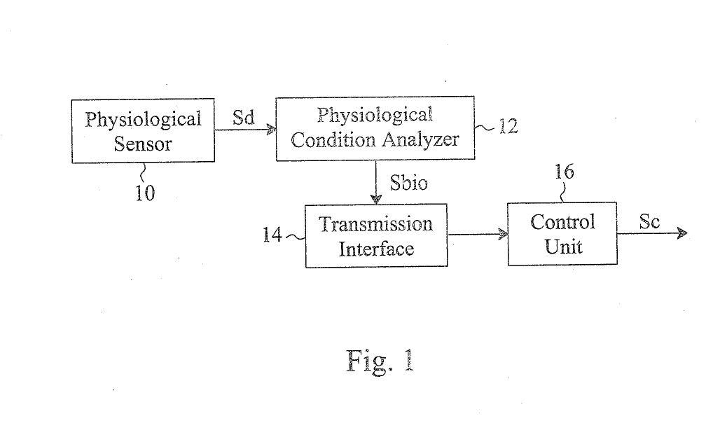

Referring to FIG. 1, a biofeedback control system according to the present invention includes a physiological sensor 10 configured to monitor a physiological condition of a user and thereby generate a sensing signal Sd including a physiological information of the user, a physiological condition analyzer 12 coupled to the physiological sensor 10 and configured to receive the sensing signal Sd to analyze the physiological information, so that a physiological variation information is extracted to generate a biofeedback signal Sbio, a transmission interface 14 coupled to the physiological condition analyzer 12 and configured to receive the biofeedback signal Sbio to transmit the physiological variation information, and a control unit 16 coupled to the transmission interface 14 and configured to receive the physiological variation information to generate a control signal Sc for a host where a program is playing or a game is running, to adjust scenes, scenarios, background music or audio-visual effects of the program or the game to enhance amusement. In this system, the physiological sensor 10 is arranged close to the user, while the physiological condition analyzer 12 and the transmission interface 14 may be close to or distant from the user. The control unit 16 is typically a part of a host, for example, a processor of a notebook computer, a processor of a home theater set or a multimedia computer, a processor of a gaming control device, or an engine of an electronic game.

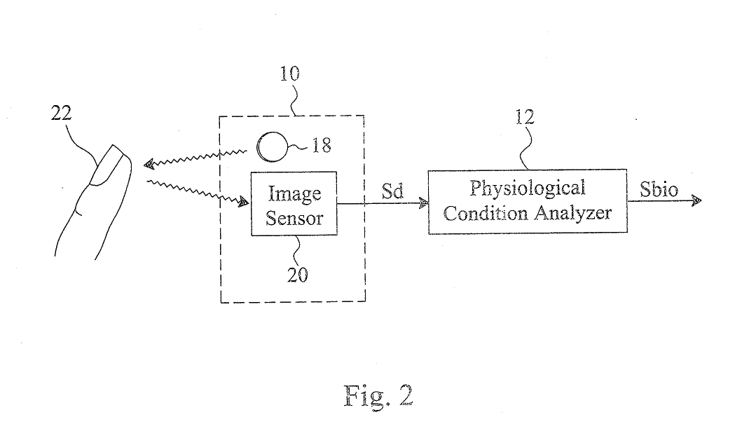

Conventional physiological sensors may be used for the purpose of capturing a physiological information of a human being, for example, as shown in FIG. 2, the physiological sensor 10 includes a light source 18 and an image sensor 20, operating in such a way that, when the image sensor 20 is to capture an image of a user's finger 22, the light source 18 provides longer wavelength light such as infrared rays to project on the finger 22, and the image sensor 20 thus generates a sensing signal Sd including the video information of the captured image. When people get angry or nervous, the blood flow increases, and when people feel sad or relaxed, the blood flow decreases. Based on this fact, the blood volume pulse can be an indicator of moods of a human being. Since vena blood absorbs longer wavelength light, the image of the finger 22 captured by the image sensor 20 will have a level of brightness depending on the blood flow of the finger 22. The physiological condition analyzer 12 can then to extract the brightness variation of images captured by the image sensor 20 to analyze the blood flow variation of the finger 22, and generate a biofeedback signal Sbio including this physiological variation information.

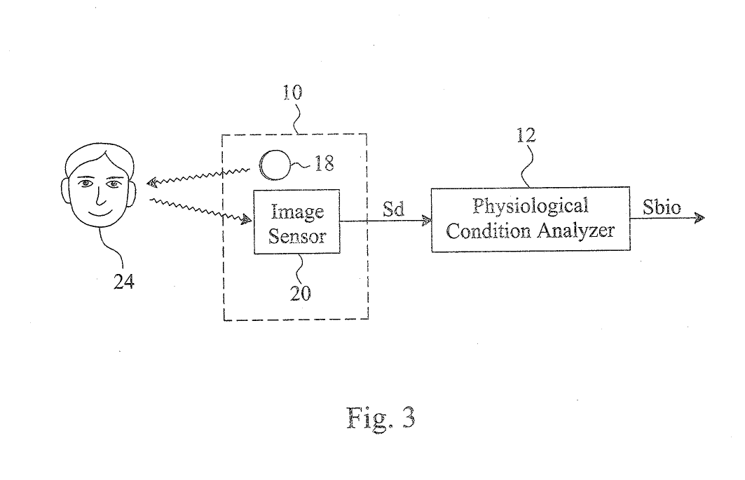

Apart from a finger, other parts of a human body may be detected for recognizing a user's mood swing. For example, referring to FIG. 3, the light source 18 provides longer wavelength light to project on a human face 24, and the image sensor 20 captures images of the human face 24 to generate a sensing signal Sd. The physiological condition analyzer 12 then extracts the brightness variation of the captured. images to analyze the blood flow variation of the human face 24. In a different embodiment, the image sensor 20 may capture images of the appearance of the human face 24, and the physiological condition analyzer 12 may extract a change of facial features of the human face 24 from the captured images to analyze the user's expression change, thereby identifying the user's mood swing.

Plate electrodes have been extensively used as physiological sensors. Therefore, in some other embodiments, plate electrodes may be employed as the physiological sensor 10 and attached to a user's body for tracing a human bioelectricity variation, thereby generating the sensing signal Sd. The physiological condition analyzer 12 analyzes the human bioelectricity variation and generates a biofeedback signal Sbio accordingly. By contacting different parts of the user, the plate electrodes can detect different human bioelectricity variations and give out such as electroencephalography (EEG), electrocardiography (ECG), and skin conductance responses (SCR), all be useful to tell a user's mood swing. For getting EEG, the plate electrodes are attached to a user's scalp, and the graph is generated by a potential difference between the detector electrode and the reference electrode. Under positive and negative moods, the obtained brain frequencies have very different patterns. ECG is a graphic tracing of the voltage generated by the heart muscle during a heartbeat, with a regular pattern. In medical practice, ECG is often considered for determining the heart rate (HR). HR can be figured out from intervals between wave peaks and its reciprocal is the heart rate variability (HRV). When a person feels happy and relaxed, HRV is low, and when a person is under stress or feels frustrated, HRV is high. To collect SCR, plate electrodes are attached to the skin of, typically a finger, for measuring the skin's electric conductivity that is linearly related to the arousal levels of moods and represents the status of the autonomic nervous system, so is also a useful indicator of moods and body alertness.

Various physical data may be used in combination for giving improved accuracy of mood identification.

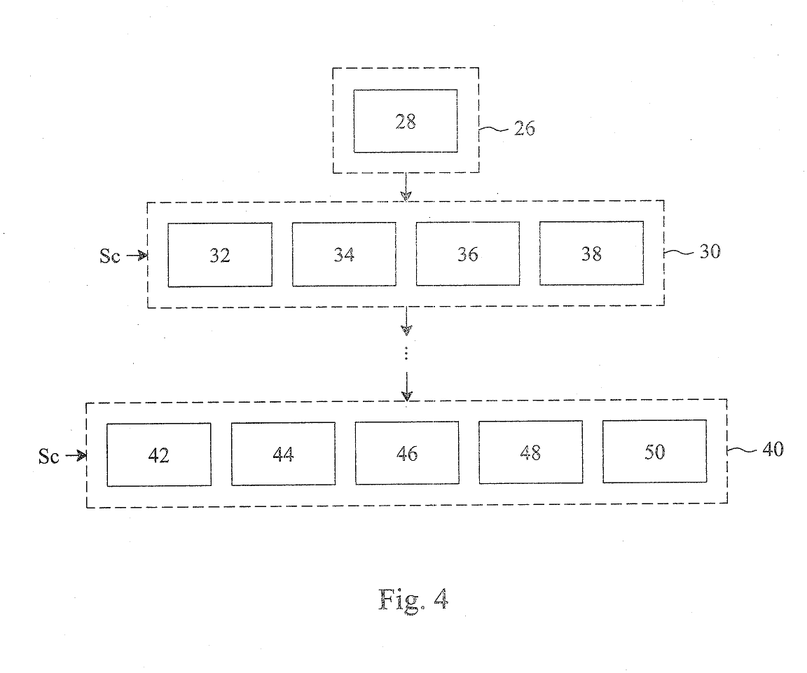

In a case where the biofeedback control system shown in FIG. 1 is used to control a program, the program is divided into a plurality of linkable segments. As shown in FIG. 4, there is only a starting segment 28 in a first stage database 26. In the process of a play of the segment 28, the biofeedback control system monitors a mood swing of a user, i.e. a viewer of the program, and selects one segment from segments 32-38 stored in the second stage database 30 accordingly. For example, assuming that the segment 36 is selected, a first clip of the segment 36 is loaded into a buffer memory before the end of the segment 28, to achieve seamless play. Further developments of the scenario of the program are controlled in the same manner. A last stage database 40 stores five endings, namely segments 42-50. Thereby, the overall scenario and the ending of the program are adjusted by tracing the user's mood swing.

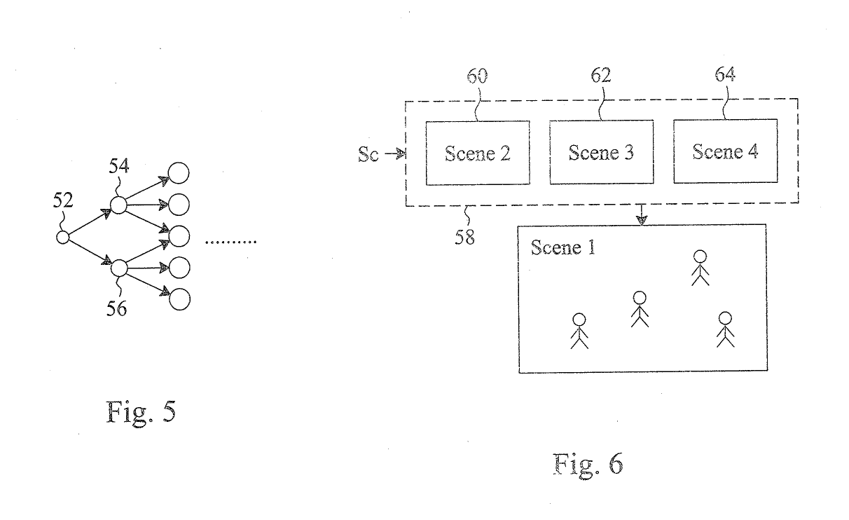

The present invention may be applied to a video game in a similar way. Referring to FIG. 5, the game always starts with a same beginning and, when coming to a scenario fork 52, the biofeedback control system selects a scenario according to the monitored player mood swing, so the next scenario fork may be 54 or 56. The game develops in this way until its ending. Since the scenario development is adjusted based on the player's real-time mood swing, the game may every time be played with different scenarios.

Referring to FIG. 6, during the process of a game, even if characters currently appearing are the same, the biofeedback control system may choose any one of scene files 60, 62, and 64 from a database 58 based on the player's mood swing to replace the current scene.

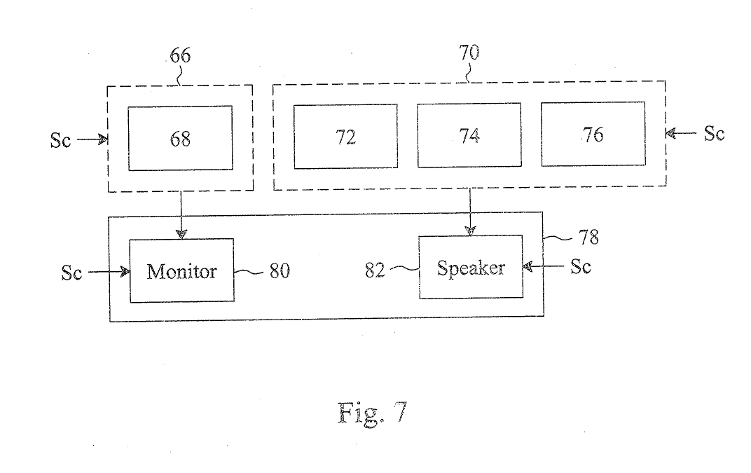

Referring to FIG. 7, for a program or a video game, the biofeedback control system is capable of changing audio-visual effects by tracing its user's mood swing. For example, the biofeedback control system can change hues of a film file 68 in a video processing unit 66, or select different background music or sound effects 72, 74, and 76 from a database 70, or directly control a monitor 80 or a speaker 82 in an output unit 78 by, for instance, adjusting brightness or color tones of the monitor 80, or adjusting sound volume of the speaker 82. In some other embodiments, the biofeedback control system may adjust the play speed of a film or music, or adjust an equalizer of a driver.

When a user is listening to music, the biofeedback control system may adjust the play mode of the music by tracing a user's mood swing, by, for example, transposing upward or downward, making the music louder or quieter, adjusting the equalizer, emphasizing or weakening some particular passages, and so on.

While the present invention has been described in conjunction with preferred embodiments thereof, it is evident that many alternatives, modifications and variations will be apparent to those skilled in the art, Accordingly, it is intended to embrace all such alternatives, modifications and variations that fall within the spirit and scope thereof as set forth in the appended claims.

What is claimed is:

1. A biofeedback control system for human-machine interface, comprising:
a physiological sensor configured to monitor a physiological condition of a user for generating a sensing signal including a physiological information of the user;
a physiological condition analyzer coupled to the physiological sensor, operative to receive the sensing signal and extract a physiological variation information from the physiological information for generating a biofeedback signal including the physiological variation information;
a transmission interface coupled to the physiological condition analyzer, operative to receive the biofeedback signal and transmit the physiological variation information; and
a control unit coupled to the transmission interface, configured to receive the physiological variation information from the transmission interface and generate a control signal based on the physiological variation information for controlling scenes, scenarios, background music or audio-visual effects of a program or a game.

2. The biofeedback control system of claim 1, wherein the physiological sensor comprises:
a light source configured to provide light to project on a finger of the user; and
an image sensor configured to capture images of the finger and generate the sensing signal including a video information of the images.

3. The biofeedback control system of claim 2, wherein the physiological condition analyzer extracts a brightness variation of the images to analyze a blood flow variation of the finger for generating the biofeedback signal.

4. The biofeedback control system of claim 1, wherein the physiological sensor comprises:
a light source configured to provide light to project on a face of the user; and
an image sensor configured to capture images of the face and generate the sensing signal including a video information of the images.

5. The biofeedback control system of claim 4, wherein the physiological condition analyzer extracts a brightness variation of the images to analyze a blood flow variation of the face or a change of facial features of the face to analyze an expression change of the user for generating the biofeedback signal.

6. The biofeedback control system of claim 1, wherein the physiological sensor comprises a plate electrode contacting a body of the user for sensing a bioelectricity variation of the body for generating the sensing signal.

7. The biofeedback control system of claim 6, wherein the physiological condition analyzer analyzes the bioelectricity variation for generating the biofeedback signal.

8. A biofeedback control method for human-machine interface, comprising:
a.) monitoring a physiological condition of a user for generating a sensing signal including a physiological information of the user;
b.) extracting a physiological variation information from the physiological information for generating a biofeedback signal including the physiological variation information; and
c.) generating a control signal based on the physiological variation information for controlling scenes, scenarios, background music or audio-visual effects of a program or a game.

9. The biofeedback control method of claim 8, wherein the step a comprises:
providing light to project on a finger of the user; and
capturing images of the finger and generating the sensing signal including a video information of the images.

10. The biofeedback control method of claim 9, wherein the step b comprises extracting a brightness variation of the images to analyze a blood flow variation of the finger for generating the biofeedback signal.

11. The biofeedback control method of claim 8, wherein the step a comprises:
providing light to project on a face of the user; and
capturing images of the face and generating the sensing signal including a video information of the images.

12. The biofeedback control method of claim 11, wherein the step b comprises extracting a brightness variation of the images to analyze a blood. flow variation of the face or a change of facial features of the face to analyze an expression change of the user for generating the biofeedback signal.

13. The biofeedback control method of claim 8, wherein the step a comprises sensing a bioelectricity variation of the user for generating the sensing signal.

14. The biofeedback control method of claim 13, wherein the step b comprises analyzing the bioelectricity variation for generating the biofeedback signal.
